(19) United States
(12) Patent Application Publication
(10) Pub. No.: US 2025/0383253 A1
(43) Pub. Date: Dec. 18, 2025

(54) SAFETY SYSTEM FOR DETECTING A COLLISION OF A MEDICAL TABLE

(71) Applicant: MAQUET GMBH, Rastatt (DE)

(72) Inventors: Thibaut REMPP, Haguenau (FR); Andreas PUDER, Rastatt (DE); Achim SCHÄFER, Iffezheim (DE); Rodrigo DEL ALCAZAR VON BUCHWALD, Waldbronn (DE)

(21) Appl. No.: 18/877,230

(22) PCT Filed: Jun. 19, 2023
(86) PCT No.: PCT/EP2023/066479

§ 371 Date: Dec. 19, 2024

(30) Foreign Application Priority Data
Jun. 20, 2022 (DE) 10 2022 115 287.1

(51) Int. Cl. G01L 5/00; A61G 13/10; G01L 5/16; G08B 21/02

(52) U.S. Cl. CPC G01L 5/0052; A61G 13/10; G01L 5/16; A61G 2203/32; A61G 2203/40; A61G 2203/42; A61G 2203/72; G08B 21/02

(57) ABSTRACT

A system (200) for detecting a collision of a patient bearing device (18) with an object, a ground or a part of the operating table, wherein the system (200) comprises: a patient bearing device (18) which can be used as a part of an operating table; a load sensor arrangement with at least one load sensor which issues sensor values; a load determination unit which determines a load with the sensor values, wherein the load comprises a load acting on the load sensor arrangement or a load acting on the patient bearing device (18); and a detection unit which detects a possible collision of the patient bearing device (18) with an object, a ground or a part of the operating table if the load determined by the load determination unit falls below a specified first threshold while the patient bearing device (18) or at least one segment of the patient bearing device (18) moves downwards.

The present application claims the priority of the German patent application No. 10 2022 115 287.1, submitted at the German Patent and Trademark Office on 20 Jun. 2022. The disclosure content of the German patent application No. 10 2022 115 287.1 is herewith incorporated in the disclosure content of the present application.

### TECHNICAL FIELD

The present disclosure relates to medical and surgical tables where the table plate and/or segments of the table plate are movable. In particular, it relates to systems which can detect a collision of a table. For example, the table plate, while it is being lowered, can collide with an object or a segment of the table plate, while lowering, can hit a foot of the table.

### BACKGROUND OF THE DISCLOSURE

Operating tables serve to bear a patient, for example during a surgical intervention. At present, nurses and doctors have to consider many important aspects due to the flexibility when setting up the operating table, the number of accessory parts and the different possibilities of positioning the patient the operating table offers, in order to be able to use the operating table correctly. For example, the equipment used and the configuration of the equipment should be adapted to the weight of the patient. Also, the patient bearing device on which the patient is located should be displaced, tipped or trended within allowable limits only. When adjusting the operating table, it should be guaranteed that the patient is correctly secured and does not fall or slide from the operating table. Furthermore, when adjusting the operating table, it should be made sure that the operating table does not collide with an external object, e.g. a C-arm.

During operations, operating tables are often covered with covers. If the patient bearing device is electrically displaced in order to position the patient, the patient bearing device can easily collide with surrounding objects. The operating table itself or the covers located on the operating table can impact the view of a user displacing the operating table. This can lead to a collision with an object which is not in the field of view of the user. Inattentiveness of the user can also cause a collision.

Patient bearing devices of operating tables can have exchangeable, detachably connectable segments. Often, some or all of the exchangeable segments are movable. Through the use of different exchangeable segments, a single operating table can be reconfigured in different ways for different patients and medical procedures. Furthermore, individual segments or the complete patient bearing device can be adjusted in different ways. For example, individual segments or the complete patient bearing device can be trended or tilted or displaced in the longitudinal or lateral direction. When displacing individual segments or the complete patient bearing device, it is possible that the segment or the patient bearing device hits another part of the operating table, for example the foot of the operating table. Furthermore, the patient bearing surface or a segment thereof can also collide with the ground on which the operating table stands.

A collision of the patient bearing device with an external object, the ground or another part of the operating table can damage expensive equipment. Furthermore, a collision can injure people, for example, body parts can become trapped.

An occurring collision should be recognised and the movement of the patient bearing device should be stopped quickly in order to limit the force or the pressure on the collision point. Thus, damage of external devices, of people and of the operating table itself can largely be avoided.

Document U.S. Pat. No. 10,646,191 B2 discloses a collision avoidance system and method for a bed which can be used in a medical application. The system comprises stress sensors which measure a stress caused by supporting the bed surface of the bed with and/or without a load on the bed surface and issue corresponding stress data. Furthermore, a collector is provided, which communicates with the stress sensors and collects the stress data issued by each of the stress sensors. An evaluation processor is connected to the collector and determines whether the collected stress data increase progressively or decrease progressively within a preset time period, wherein a progressive increase or a progressive decrease of the collected load data within the preset time period indicates that the bed surface has hit an object. The system also comprises a controller which controls the bed surface so that the bed surface stops moving if the evaluation processor determines that the detected stress data increased or decreased progressively within the preset time period. U.S. Pat. No. 10,646,191 B2 does not disclose a collision detection system which detects a possible collision of a patient bearing device with an object if the load determined by a load determination unit falls below a specified threshold, while the patient bearing device or at least one segment of the patient bearing device moves downwards. U.S. Pat. No. 10,646,191 B2 does not teach a system either which temporarily suspends the collision detection features in response to a sudden weight increase.

### SUMMARY OF THE DISCLOSURE

It is an object of the present disclosure to provide a system which is advantageously designed to detect a possible collision of a patient bearing device with an object.

Additionally, the system can be embodied to stop a movement of the patient bearing device if a collision was detected.

According to a first aspect of the present disclosure, a system is provided which is adapted to detect a collision of a patient bearing device with an object, a ground or a part of an operating table. The system can have a patient bearing device, a load sensor arrangement with at least one load sensor and a detection unit.

The patient bearing device can be used as a part of an operating table and can serve to bear a patient. In some designs, the patient bearing device can be a surgical patient bearing device on which a patient is borne during a surgical procedure. Further, the patient bearing device can serve to fasten accessory parts. The patient bearing device can be modularly formed and have a bearing surface main section which can be extended by coupling diverse bearing surface subsections. The bearing surface main section and the bearing surface subsections can have mechanical connection elements with which the bearing surface main and subsections can be detachably connected. Bearing surface subsections can be leg, foot or head sections, for example. Furthermore, the bearing surface subsections can also be extension or intermediate sections which are inserted between the bearing surface main section and the head section, for example. Sliding or lateral rails can be attached on the sides of the bearing surface main and subsections. Accessory parts can be detachably fastened on the sliding or lateral rails.

In some designs, the patient bearing device can be firmly connected to a column of an operating table. The operating table can be movable. A foot or a base of the operating table can have wheels or rolls with which the operating table can be moved on the ground. Alternatively, the foot or the base can be fixedly anchored on the ground.

In some designs, the patient bearing device can be designed so that it can be detachably connected to a movable surgical patient transporter and a column of an operating table. The patient bearing device can be mounted on the patient transporter before a surgical procedure. The patient can be brought to the operating table with the patient transporter. There, the patient bearing device can be fastened to the operating table column and be decoupled from the patient transporter. A large part of the preparations to the surgical procedure can be done while the patient bearing device is mounted on the patient transporter. For example, the patient bearing device can be assembled from individual segments and accessory parts and the patient can be prepared for the surgical procedure. Only when the preparations are completed, the patient bearing device can be fastened to the operating table column.

The load sensor arrangement can have one or more load sensors. A single load sensor can be sufficient if only the load is to be determined. But the load sensor arrangement can also contain several load sensors, for example two, two or more, three, three or more or four load sensors or also further load sensors. This is useful, in particular, if the centre of the load is to be determined in addition to the load. If a 6D force measurement sensor is used, the centre can also be calculated with a single load sensor. The at least one load sensor can issue sensor values from which a load acting on the load sensor arrangement and furthermore also a load acting on the patient bearing device can be determined. The load acting on the load sensor arrangement can in particular comprise all external force sizes, i.e. forces and torques, acting of the load sensor arrangement.

The load sensors can be force sensors, in particular weighing cells, for example, which respectively measure a force acting on the respective sensor. The force sensors can issue a respective electrical signal, for example an electrical voltage, as the output signal from which the respective measured force can be derived. Furthermore, it can also be provided that the force sensors issue the respective specific size of the respective force measured by them, e.g. in a digital form, as a sensor value.

It is further conceivable that the load sensor arrangement determines a resulting total force from the sensor values of several load sensors, wherein the resulting total force results from the individual forces acting on the different force sensors.

The load acting on the load sensor arrangement comprises, for example, the load caused by the components of the operating table that are arranged above the load sensor arrangement and the load caused by the patient borne on the patient bearing device or other objects located on the patient bearing device. Further, a person standing next to the operating table can also cause a load on the patient bearing device, for example by the person supporting themselves on the patient bearing device with a hand or another body part. Moreover, external forces created in another way can create a load on the patient bearing device. Such loads can also be measured by the load sensor arrangement.

The load sensor arrangement can be arranged at different positions in the operating table. In some designs, the load sensor arrangement can be integrated into the column of the operating table or in the patient bearing device. Furthermore, the load sensor arrangement can be arranged on or adjacent to interfaces which the column forms with the patient bearing device or the foot (e.g. the base). Consequently, the load sensor arrangement can be arranged between the patient bearing device and the column, for example. Alternatively, the load sensor arrangement can be arranged between the column and the foot, for example.

In some designs, the load sensor arrangement can be integrated in the patient transporter.

The load sensor arrangement can be integrated in the operating table or the patient transporter so that the full load flows through the load sensor arrangement or is transmitted by it. In particular, the load which is caused above the load sensor arrangement can flow through the load sensor arrangement or be transmitted by it.

The load determination unit can be coupled to the load sensor arrangement and obtain the sensor values issued by the one or the several load sensors. With the sensor values, the load determination unit can determine a load and, if desired, a centre of the load in a specified coordinate system. The load can comprise a load acting on the load sensor arrangement or a load acting on the patient bearing device. The load can be indicated by the load determination unit in the form of a weight, in particular in the unit of kilograms, for example, or in the form of a force, in particular a gravitation force, in the unit of Newton, for example. In some designs, the load determined by the load determination unit can be a load acting on the load sensor arrangement or a load acting on the patient bearing device or a total load of the operating table or a total load of the patient transporter on which the patient bearing device is mounted. The load centre can be indicated relative to a defined point of the patient bearing device or of the operating table. Furthermore, the load centre can also be indicated in a coordinate system which is optionally not referred to the patient bearing device or the operating table, but whose origin is tied to an external point, for example a defined point in the operating theatre. Thus, the absolute position of the load centre can be indicated.

The load acting on the load sensor arrangement can also be referred to as measuring load. The measuring load corresponds to the load which is created by all persons, objects and forces on the operating table or the patient transporter above the load sensors. The measuring load corresponds to the load value which is measured by the load sensor arrangement.

The load acting on the patient bearing device can be referred to as an active load and corresponds to the load which is caused by components which are not assigned to the patient bearing device or the operating table or the patient transporter and persons and external forces and acts on the patient bearing device. Components assigned to the patient bearing device can be components which are recognised by means of a detection system, e.g. bearing surface sections or segments and/or other accessory parts. The active load does not take into account the influence of components assigned to the patient bearing device or the operating table or the patient transporter. Only the other components contribute to the active load, i.e. the components which are not assigned to the patient bearing device or the operating table or the patient transporter. These can be accessory parts, for example, which are not recognised by the detection system, or other objects which are placed on the patient bearing device. Furthermore, the patient located on the patient bearing device contributes to the active load. Moreover, all forces acting externally on the patient bearing device, which are applied to the patient bearing device by persons and/or objects outside the patient bearing device for example, contribute to the active load.

If the patient bearing device is mounted on the column of the operating table or the patient transporter, the total load of the operating table or of the patient transporter can also be determined. The total load of the operating table or the patient transporter is the load which results from the measuring load and from a load caused by components which are assigned to the operating table or the patient transporter and are below the load sensor arrangement. Consequently, the total load considers loads from components which are located below the load sensor arrangement and cannot be measured by the load sensor arrangement and thus do not contribute to the measuring load. Consequently, the total load is the load which results from the complete operating table or the patient transporter, the patient, the components assigned to the operating table or the patient transporter, the components not assigned to the operating table or the patient transporter and other external forces.

The detection unit can be coupled to the load determination unit and can contain the sizes determined by the load determination unit, i.e. the load and optionally the load centre. The detection unit can detect a possible collision of the patient bearing device with an object, a ground or a part of the operating table during a downwards movement of the patient bearing device or at least one segment of the patient bearing device. Such a collision causes a decrease of the load determined by the load determination unit. The detection unit detects a possible or potential collision of the patient bearing device with an object, a ground or a part of the operating table if the load determined by the load determination unit falls below a specified first threshold while the patient bearing device or the at least one segment of the patient bearing device moves downwards.

A collision detected by the detection unit, as is described here, also comprises a collision of an accessory part fastened to the patient bearing device with an object, a ground or a part of the operating table. For example, an accessory part can be fastened to a sliding or lateral rail and hit another item during a downwards movement of the patient bearing device. Such a collision causes a decrease of the load determined by the load determination unit.

If a possible collision is recognised, the movement of the patient bearing device can be stopped quickly and the force or the pressure on the collision point be limited. Thus, damage of external devices, of people and of the operating table itself can largely be avoided. The quicker the movement of the patient bearing device is stopped, the more the pressure on the collision site can be limited.

A downwards movement of the patient bearing device or of a segment of the patient bearing device is a movement where at least a part of the patient bearing device or of the segment moves downwards, i.e. in the direction of the ground on which the operating table stands. The downwards movement can be in different ways. For example, the patient bearing device can be trended or tilted. A trend of the patient bearing device is also referred to as a Trendelenburg trend where the patient is borne so that the head of the patient is down and the pelvis of the patient is further up. An anti Trendelenburg trend is where the head of the patient is positioned high while the pelvis is further below. A tilt means that the patient bearing device is trended to the side. A trend or tilt of the patient bearing device is about one or more joints. The part of the patient bearing device on one side of the one or more joints moves downwards, while the part on the other side of the joints can move upwards.

The patient bearing device can be trended or tilted as a whole. Furthermore, it is possible that only one or more segments of the patient bearing device are moved downwards by adjusting, in particular trending or tilting the segment or the segments, for example. For example, a leg section of the patient bearing device can be trended downwards.

Furthermore, the patient bearing device can be moved downwards as a whole by means of a lifting column. If there is no simultaneous trend or tilt, the trend and tilt angles of the patient bearing device are maintained during the downwards movement.

During a downwards movement of the patient bearing device or a segment of the patient bearing device, a collision with an item can occur. The item can be an object, for example, which is below the patient bearing device. Furthermore, the patient bearing device can collide with the ground on which the operating table is located. Further, the patient bearing device can hit another part of the operating table. For example, a trend of the complete patient bearing device or of only a segment, e.g. a leg section, can result in the patient bearing device or the segment colliding with the foot of the operating table.

As described, the detection unit can monitor the load determined by the load determination unit and, during a downwards movement of the patient bearing device or of the at least one segment of the patient bearing device, detect if the load falls below the specified first threshold. A collision of the patient bearing device or of a part thereof causes such a load drop. But a load drop can also have other reasons. For example, an item can be removed from the patient bearing device during the downwards movement. This would also cause a load drop. Consequently, from the load drop alone, it can only be concluded that a collision has possibly occurred.

The specified first threshold can be referred to a reference value. In some designs, the reference value can be a load determined by the load determination unit directly before the beginning of the downwards movement. The first threshold can be defined so that it is lower than the reference value and has a specified distance from the reference value. The value of the first threshold or the distance of the first threshold from the reference value is a measure of the sensitivity of the collision detection. The lower the distance of the first threshold from the reference value, the higher the sensitivity of the collision detection. The greater the distance of the first threshold from the reference value, the more load decrease is required in order to trigger the collision detection. Consequently, the greater the distance of the first threshold from the reference value, the more pressure is caused on the collision point or the more force acts on the collision point. Conversely, a faulty collision detection becomes all the more likely the lower the distance of the first threshold is from the reference value.

The system described herein can optionally also be designed to detect a possible collision of the patient bearing device with an object, a ground or a part of the operating table not only during a downwards movement, but also during an upwards movement of the patient bearing device or at least one segment of the patient bearing device. Such a detection during an upwards movement can be carried out by the described detection unit or a further detection unit, for example.

The load determination unit and/or the detection unit can either be integrated in the operating table or the patient transporter or be outside the operating table or the patient transporter. For example, the load determination unit and/or the detection unit can be integrated in a calculation unit which is outside the operating table or the patient transporter and is connected to the operating table or the patient transporter wirelessly or by a fixed wiring, for example.

If an additional load is applied to the patient bearing device during a downwards movement, for example by a person supporting themselves on the patient bearing device or an item being placed on the patient bearing device or fastened thereto, the load determined by the load determination unit increases. Further, a push from above can be exerted on the patient bearing device. This can lead to load vibrations causing a fall below the first threshold although no collision has taken place. In order to avoid such a faulty detection or make it less probable, the detection unit can be designed in some designs so that the detection unit temporarily does not indicate a possible collision or temporarily interrupts the collision detection after the load determined by the load determination unit has exceeded a specified second threshold.

The second threshold can be greater than the first threshold. The second threshold can be defined so that it is greater than the reference value and has a specified distance from the reference value, wherein the reference value is the load determined by the load determination unit directly before the beginning of the downwards movement. In some designs, the amount of the distance of the first threshold from the reference value can be equal or approximately equal to the distance of the second threshold from the reference value. It can also be provided that the amount of the distance of the first threshold from the reference value and the distance of the second threshold from the reference value do not differ by more than 10% or 20% or 30%.

After the load determined by the load determination unit has exceeded the second threshold, the detection unit cannot indicate a possible collision for a certain time in order to prevent a faulty collision detection. This time can be referred to as “snooze time” and have a specified duration, e.g. in the range from 0.5 to 10 seconds or longer.

In some designs, faulty collision detections can be avoided by specifying a third threshold which is smaller than the first threshold. The collision detection can be suspended after the load determined by the load determination unit has exceeded a specified second threshold. The second threshold can be designed as described above. The detection unit temporarily detects a possible collision only if the load determined by the load determination unit falls below the third threshold. As the third threshold is lower than the first threshold, the load decrease must be greater in order to be able to detect a possible collision. Thus, faulty collision detections can be avoided in a time window after exceeding the first threshold, but actually occurring collisions can be detected.

The time window in which the detection unit detects a possible collision only if the third threshold is fallen below, can have a specified duration, e.g. in the range from 0.5 to 10 seconds or longer.

In some designs, the first threshold and/or the second threshold and/or the third threshold can each be individually specified at least for a part of the axes about which the patient bearing device or the at least one segment of the patient bearing device can be trended or tilted during the downwards movement, and/or for a lowering of the patient bearing device by means of a lifting column. Consequently, one or more of the three different thresholds can be specified for each or a part of the joints which cause a trend or tilt of the patient bearing device or of the segment. Thus, in particular the sensitivity of the collision detection can be individually set for each or a part of the joints.

The load detection unit can determine a different load as a function of the trend and/or tilt of the patient bearing device. In some designs, one or more or all thresholds from the group of the first, the second and the third thresholds can each be variable. For example, the respective thresholds can depend on a trend angle and/or a tilt angle of the patient bearing device or of the at least one segment of the patient bearing device. Thus, the dependency of the load determined by the load determination unit on the trend and/or tilt angle can be at least partially compensated. The respective thresholds can depend on the adjustment or position of one or more joints. If the position of one or more joints changes continuously during a downwards movement, the thresholds can also be changed continuously.

In some designs, an amount of a distance of the first threshold from a load determined by the load determination unit directly before the beginning of the downwards movement can be approximately equal to a distance of the second threshold from the load determined before the beginning of the downwards movement. If the thresholds are variable, the first and the second thresholds can be adjusted in the same way during the downwards movement so that their distance is always equal.

As described above, the load determined directly before the beginning of the downwards movement can serve as a reference value to which in particular the first and the second thresholds refer. Alternatively, the output of a very slow sliding mean value filter over the load determined by the load determination unit can also be used as a reference value.

In some designs, the detection unit can monitor the load determined by the load determination unit during the downwards movement and set the first threshold and/or the second threshold so that a distance of the first threshold and/or a distance of the second threshold from the load determined by the load determination unit are constant or at least approximately constant during the downwards movement. In other words, the detection unit can track the thresholds of the load changing during the downwards movement. However, these should only be minor changes of the thresholds so that an actual collision can be detected.

Above, it was described that the detection unit detects a possible collision of the patient bearing device with an object, a ground or a part of the operating table if the load determined by the load determination unit falls below a specified first threshold while the patient bearing device or at least one segment of the patient bearing device moves downwards. It cannot necessarily be derived that a collision has occurred from the fact that the load falls below the first threshold. The falling below the first threshold can also be due to other reasons. Thus, the detection unit can be designed so that it considers further conditions in addition to the stated condition in order to be able to decide whether a possible collision has taken place. In the following, additional conditions for a possible collision of the patient bearing device with an object, a ground or a part of the operating table are stated. The additional conditions can be combined with one another in any form. It is also conceivable that only one of the conditions stated in the following for the detection of a possible collision is used.

Apart from the load, the load determination unit can additionally determine a centre of the load with the sensor values in some designs. During a movement of the patient bearing device without a collision, the load centre changes slowly and in a predictable manner with regard to the movement axis, the movement direction and the movement speed. In case of a collision, the centre changes abruptly, in particular about one or more axes. Therefore, the detection unit can determine as an additional condition for a possible collision of the patient bearing device with an object, a ground or a part of the operating table whether the load centre determined by the load determination unit changes abruptly during the downwards movement of the patient bearing device or the at least one segment of the patient bearing device. An abrupt change can be determined, for example, if the load centre changes by at least one specified amount, e.g. at least by 3 cm or 5 cm or 10 cm or 15 cm or 20 cm within a specified time duration, e.g. a time duration of less than 2 s or 1 s or 0.5 s or 0.3 s or 0.1 s.

As the load centre changes constantly during the movement of the patient bearing device, it can be challenging to detect a jump of the centre caused by a collision.

Furthermore, the abrupt change of the centre during a collision depends strongly on the current centre position and the collision site. The greater the distance between the centre and the collision site, the greater or better the detection of the influence on the centre position. The worst case is a collision with an object on the current centre site. In this case, the abrupt change of the centre is quite small.

Furthermore, the heavier the patient, the smaller the abrupt change of the centre during a collision.

The factors stated above can be considered when setting the detection threshold.

In some designs, the detection unit can determine a force caused by a possible collision and acting on the patient bearing device and/or a site where the patient bearing device possibly collides with an object, a ground or a part of the operating table. During a collision, the collision force should increase and the collision site should remain approximately constant. Therefore, the detection unit can determine as an additional condition for a possible collision of the patient bearing device with an object, a ground or a part of the operating table whether the force caused by the possible collision increases during the possible collision and/or the collision site is approximately constant. If this is the case, the detection unit can determine that a possible collision has taken place. It can be provided that the collision site is regarded as approximately constant if it does not change by more than 5 cm or 10 cm or 20 cm or 30 cm during the collision, for example.

The observation of the collision force and/or of the collision site is especially useful in order to distinguish between a collision and a malfunction of the load sensors or another input into the load determination algorithm. If the collision site is not constant, the increase of the collision force can be due to a malfunction and not to a collision.

In some designs, the detection unit can determine the force caused by the possible collision and/or the collision site with a change, which occurred during the possible collision, of the load determined by the load determination unit and/or of the load centre determined by the load determination unit and/or of the sensor values issued by at least a part of the load sensors.

In some designs, the load sensor arrangement can have several load sensors which issue sensor values. A respective selection of the load sensors can be assigned to at least a part of the possible movements of the patient bearing device or of the at least one segment of the patient bearing device about different axes and/or by means of a lifting column. During a movement of the patient bearing device or of the at least one segment of the patient bearing device, the detection unit can analyse the forces acting on the load sensors assigned to this movement.

For example, the operating table can have a number of joints. Certain load sensors from the total of the load sensors can be assigned to each one of the joints. If the patient bearing device or the at least one segment are moved by means of one of the joints, the detection unit can analyse the forces acting on the load sensors assigned to the joint.

As an additional condition for a possible collision of the patient bearing device with an object, a ground or a part of the operating table, the detection unit can determine whether the analysed forces fall below a specified force threshold during a possible collision. If all analysed forces or several of the analysed forces or at least one force of the analysed forces fall below the force threshold, the detection unit can conclude that there is a possible collision. But the sharp drop of the forces should not be caused by the movement of the patient bearing device.

Furthermore, as an additional condition for a possible collision of the patient bearing device with an object, a ground or a part of the operating table, the detection unit can determine whether a temporal derivation of the analysed forces falls below a specified fourth threshold during a possible collision. The fourth threshold can be chosen so that it reflects a strong negative increase of the forces. If the derivation of the analysed forces falls below the fourth threshold, the detection unit can determine that there is a possible collision.

In some designs, the load sensor arrangement can have several load sensors which issue sensor values.

In some designs, the several load sensors can be arranged in a single common plane. In some designs, the load sensors can be arranged symmetrically.

In some designs, the load sensor arrangement can be arranged between at least two parts of the operating table which are substantially not movable to one another.

In some designs, the load sensors of the load sensor arrangement can be arranged parallel and mirror-inverted to one another. For example, the load sensor arrangement can have four load sensors or weighing cells in total. This design has the advantage of increased accuracy and reliability.

In some designs, several or all of the load sensors of the load sensor arrangement can be arranged mirror-symmetrically with regard to a first imaginary axis and mirror-symmetrically with regard to a second imaginary axis. The first and the second axis can be aligned orthogonally to one another. For example, the first axis can run parallel to a main axis of the patient bearing device, while the second axis runs perpendicular to this main axis, but parallel to the patient bearing device. The load sensor arrangement can be arranged between the patient bearing device and the operating table column.

In some designs, the load sensors can be arranged in a grid pattern or grid. For example, the load sensors can be arranged in a 2×2 grid. The load sensors can be arranged in a grid arrangement with 2 to 4 load sensors in each dimension, for example.

The load sensors which are arranged mirror-symmetrically can be aligned in the same direction. In particular, the load sensors which are arranged mirror-symmetrically can be aligned parallel to one another. The load sensors can each have a main axis, wherein the main axes are aligned parallel to one another.

In some designs, the load sensors of the load sensor arrangement can be structurally identical.

In some designs, the load sensors can have an elongated shape. For example, the load sensors can be rectangular bodies.

If the detection unit detects a possible collision of the patient bearing device with an object, a ground or a part of the operating table, the detection unit can create a collision signal in some designs which indicates that the operating table is in a safety-critical condition.

Further, an acoustic and/or optical warning signal can be created. Moreover, a warning signal in text form can be created, which can be displayed for the user on a remote control of the operating table, for example. Furthermore, the movement of the patient bearing device and/or of the operating table can be restricted. For example, deployment and/or trending and/or tilting of the patient bearing device and/or the movement of the operating table can be slowed down or stopped. Moreover, at least one function of the patient bearing device and/or of the operating table can be blocked.

The measures taken can be reduced or cancelled if the detection unit determines a safe condition of the patient bearing device and/or of the operating table again.

In some designs, the patient bearing device can be part of an operating table. The operating table can comprise a base or a foot and a column and the load sensor arrangement can be arranged in the column.

In some designs, the detection unit can detect a possible collision if the load determined by the load determination unit decreases by at least one collision threshold during a downwards movement of the patient bearing device or of the at least one segment of the patient bearing device. The load directly before the beginning of the downwards movement can be used as a reference value for the collision threshold. For example, the at least one collision threshold can be chosen so that it corresponds to the first threshold described above. I.e., if the load determined by the load determination unit has decreased by the at least one collision threshold, the load has simultaneously fallen below the first threshold.

In some designs, the system can set the collision threshold based on one or more of the following variables: a position of the patient bearing device, an angle of the patient bearing device, a joint angle of a joint within the patient bearing device, a displacement and/or trend and/or tilt position of the patient bearing device and a current type of movement of the patient bearing device.

If the load determined by the load determination unit increases by at least one false warning trigger amount during a downwards movement of the patient bearing device or of the at least one segment of the patient bearing device, the system can in some designs temporarily ignore all possible collisions due to decreases of the load determined by the load determination unit.

In some designs, the detection unit can compare loads determined by the load determination unit if the patient bearing device stands still with loads determined by the load determination unit if the patient bearing device later moves downwards. An indication of a possible collision can be a lower load which is measured when the patient bearing device later moves downwards. Furthermore, a load which is smaller by at least one threshold if the patient bearing device moves downwards can indicate a possible collision.

In some designs, the detection unit can only be configured to detect collisions between the patient bearing device and an object, a ground or a part of the operating table below the patient bearing device while the patient bearing device or the at least one segment of the patient bearing device moves downwards. Furthermore, the system can also comprise other separate collision detection units which detect a collision, for example, if the patient bearing device or at least one segment of the patient bearing device move upwards and/or sidewards.

According to a second aspect of the present disclosure, a method for detecting a collision of a patient bearing device with an object, a ground or a part of an operating table is provided. The patient bearing device can be usable as a part of an operating table and can in particular be a surgical patient bearing device. A load sensor arrangement with at least one load sensor which issues sensor values can be provided. A load can be determined with the sensor values, wherein the load comprises a load acting on the load sensor arrangement or a load acting on the patient bearing device. A possible collision of the patient bearing device with an object, a ground or a part of the operating table can be detected if the determined load falls below a specified first threshold while the patient bearing device or at least one segment of the patient bearing device moves downwards.

The method according to the second aspect can have all designs which are described in the present disclosure in connection with the system according to the first aspect.

The present disclosure also comprises circuits and/or electronic instructions for controlling operating tables and remote controls, displays and user interfaces for use with operating tables.

### SHORT DESCRIPTION OF THE DRAWINGS

Example embodiments of the present disclosure are explained in more detail hereinafter with the figures: In the drawings:

FIG. 1 shows a schematic lateral view of an operating table according to the disclosure with a patient positioned on a patient bearing device of the operating table;

FIG. 2 shows a schematic representation of the system architecture of a system according to the disclosure;

FIG. 3 shows a schematic representation of an operating table according to the disclosure for illustrating the measuring load, the active load and the total load;

FIGS. 4A to 4C show schematic representations of different embodiments of an operating table according to the disclosure with a load sensor arrangement in different positions;

FIGS. 5A to 5D show schematic representations of different embodiments of an operating table according to the disclosure with force sensors arranged in parallel and mirror-symmetrically;

FIGS. 6A and 6B show schematic representations for illustrating the forces acting on the force sensors;

FIGS. 7A and 7B show schematic representations for illustrating the reduction of transverse forces due to the symmetrical arrangement of the force sensors;

FIG. 8 shows a schematic representation for illustrating the determination of the gravitational vector with a trended patient bearing device;

FIGS. 9A and 9B show schematic representations of a system according to the disclosure before and during a collision of the patient bearing device with an object;

FIGS. 10A and 10B show schematic representations of a system according to the disclosure with an external load applied to the patient bearing device during a downwards movement;

FIG. 11 shows a schematic representation of a load vibration caused by an external load;

FIG. 12 shows example representations of the trend angle of the patient bearing device and the load determined by the load determination unit;

FIG. 13 shows a schematic representation of a method according to the disclosure for detecting a collision of the patient bearing device with an object;

FIGS. 14A and 14B show schematic representations of a system according to the disclosure with the load centre before and during a collision of the patient bearing device with an object;

FIG. 15 shows a schematic representation of a system according to the disclosure for illustrating the determination of a collision force and a collision site;

FIG. 16 shows a schematic representation of a system according to the disclosure for illustrating the assignment of determined load sensors to individual joints of the operating table; and

FIGS. 17A to 17C show schematic representations of different application cases of the system according to the disclosure.

### DETAILED DESCRIPTION OF THE FIGURES

In the following description, example embodiments of the present disclosure are described with reference to the drawings. The drawings are not necessarily drawn to scale, but are intended to only schematically illustrate the respective features.

It is to be noted that the features and components described below can each be combined with one another, irrespective of whether they were described in connection with a single embodiment. The combination of features in the respective embodiments only serves to illustrate the general setup and the functioning of the claimed device.

In the figures, identical or similar elements are indicated with identical reference numerals as far as this is appropriate.

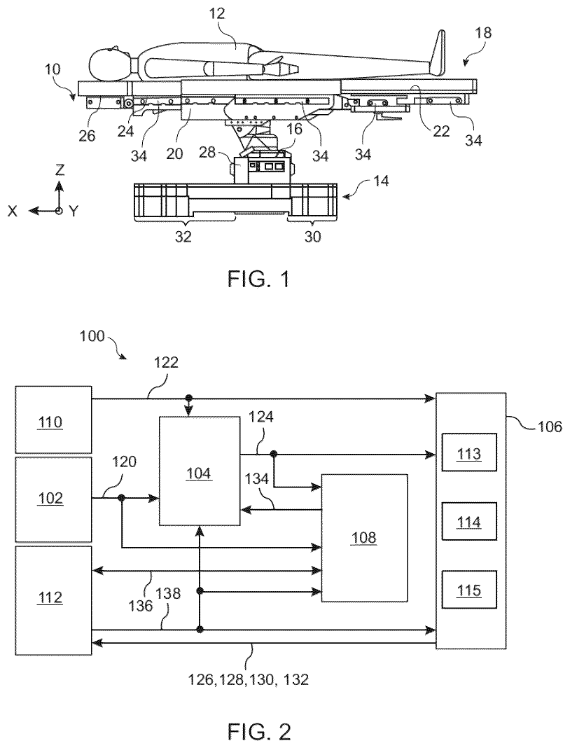

FIG. 1 schematically shows a mobile operating table 10 which can be used for bearing a patient 12 during a surgical intervention and for transporting them. The mobile operating table 10 comprises, from bottom to top, a foot or a base 14 for placing the operating table 10 on a ground, an operating table column 16 comprising the foot 14 and being perpendicularly arranged, and a patient bearing device 18 fastened at an upper end of the operating table column 16. The patient bearing device 18 can be firmly connected to the operating table column 16 or alternatively be detachably fastened on the operating table column 16.

The patient bearing device 18 is formed modularly and serves to bear the patient 12. The patient bearing device 18 comprises a bearing surface main section 20 connected to the operating table column 16 which can be extended as desired by coupling diverse bearing surface subsections. The patient bearing device 18 can be embodied as a table plate of a surgical table or of the operating table 10. In FIG. 1, a leg section 22, a shoulder section 24 and a head section 26 are coupled to the bearing surface main section 20 as bearing surface subsections.

Depending on the type of surgical intervention to be performed, the patient bearing device 18 of the operating table 10 can be brought to a suitable height and both trended and tilted.

The operating table column 16 is formed to be adjustable in height and has an internal mechanics for adjusting the height of the patient bearing device 18 of the operating table 10. The mechanics is arranged in a housing 28 which protects the components from pollution.

The foot 14 has two sections 30, 32 of different lengths. Section 30 is a short section which is assigned to a foot end of the leg section 22, i.e. the end of the patient bearing device 18 on which the feet of the patient 12 to be treated lie. Section 32 is a long section which is assigned to the head section 26 of the patient bearing device 18.

Furthermore, the foot 14 can have wheels or rolls with which the operating table 10 can be moved on the ground. Alternatively, the foot 14 can be fixedly anchored on the ground.

Lateral rails 34 are attached on both sides of the patient bearing device 18. Accessory parts can be detachably fastened on the lateral rails 34.

For better illustration, a Cartesian coordinate system X-Y-Z is inserted in FIG. 1. The X-axis and the Y-axis are the horizontal axes, the Z-axis is the perpendicular axis. The X-axis extends along the bearing surface subsections 22, 24, 26 arranged next to one another.

FIG. 2 schematically shows the system architecture of a system 100 according to the disclosure. The system 100 is a system according to the first aspect of the present disclosure and can be operated with a method according to the second aspect.

Apart from an operating table 10 as represented in FIG. 1, the system 100 has a load sensor arrangement 102, a load determination unit 104, a safety unit 106, a monitoring and calibration unit 108, a data storage 110 as well as further components 112 of the operating table system 100. Further, the safety unit 106 contains a detection unit 113, a tipping prevention unit 114 and an overload protection unit 115.

The load sensor arrangement 102 contains one or more load sensors and is formed to measure at least one size from which a load acting on the load sensor arrangement 102 can be determined. In the present case, the load sensors are force sensors which respectively measure a force acting on the respective sensor. The sensor or force values measured by the individual force sensors are issued by the load sensor arrangement 102 as a signal 120 in a digital form. Further, the load sensor arrangement 102 contains electronic components which are required for operation of the force sensors.

The load determination unit 104 receives the signal 120 with the measured sensor or force values and determines a load and in particular a centre of the load therefrom. The load determination unit 104 can determine a measuring load, an active load and/or a total load as the load.

In order to be able to adequately process and analyse the delivered force values, the load determination unit 104 requires some data relating to the geometry and the masses or weights of the operating table 10 and the accessory parts. These data are stored in the data storage 110 and are provided to the load determination unit 104 by means of a signal 122. From these data, in particular, information on the masses and centres of the individual components of the operating table 10 and the accessory parts can be taken. The data storage 110 can be extended via a connectivity module of the operating table 10.

The load determination unit 104 creates a signal 124 as an output signal which contains information on the determined loads and load centres. These information are transmitted both to the safety unit 106 and to the monitoring and calibration unit 108.

In the safety unit 106, all available data are analysed, including the loads, centres and the position data of the operating table 10 and the accessory parts recognised by the operating table 10. The safety unit 106 decides whether the operating table 10 is safe or whether it is in a dangerous situation. The safety unit 106 creates a safety signal 126 which indicates whether the operating table 10 is in a safety-critical condition.

Depending on the severity of the detected situation, the algorithm reacts correspondingly. The operating table 10 can only issue a warning, for example, or stop the movement. The warnings can be via an acoustic or optical signal through the operating table 10 or in the form of text via the remote control. The measures can vary from slowing down the movement speed to stopping the movement or blocking some functions and last until a condition is reached in which the operating table 10 is safe again.

It can be provided that the safety features can be deactivated by the user at all times and the movement of the operating table 10 is continued at their own risk.

The detection unit 113 is a subunit of the safety unit 106 and obtains the loads and load centres determined by the load determination unit 104. The detection unit 113 detects possible collisions of the patient bearing device 18 with an object, a ground or a part of the operating table 10 while the patient bearing device 18 or at least one segment of the patient bearing device 18 moves downwards. The detection unit 113 creates a collision signal 128 which indicates whether a possible collision has taken place. The collision signal 128 is a safety signal of the safety unit 106.

The tipping prevention unit 114 and the overload protection unit 115 are further subunits of the safety unit 106. With the total load and/or the centre of the total load, the tipping prevention unit 114 creates a tipping safety signal 130 which indicates whether there is a risk of the operating table 10 tipping. With the active load and/or the centre of the active load, the overload protection unit 115 creates an overload protection signal 132 which indicates whether there is an overload risk for the operating table 10 and/or at least one component of the operating table 10. Alternatively, the overload protection unit 115 can use the measuring load or the total load and/or the centre of one of these loads for creating the overload protection signal 132. Both the tipping safety signal 130 and the overload protection signal 132 are safety signals of the safety unit 106.

If the foot 14 does not have any wheels or rolls and instead is firmly connected to the ground, the tipping prevention unit 114 can be deactivated or not be implemented in the safety unit 106.

As the system 100 is to recognise critical situations reliably, the system 100 also has a monitoring and calibration unit 108. This software module checks the plausibility of the measuring values and recognises whether the system works incorrectly or whether a calibration or taring of the system 100 is required. The monitoring and calibration unit 108 creates corresponding output signals 134, 136, which are transmitted to the load determination unit 104 or the components 112 of the operating table 10.

The components 112 of the operating table 10 continuously generate position data, data for adjusting individual components and information on the accessories recognised by the operating table 10. These data are provided to the system 100 with a signal 138.

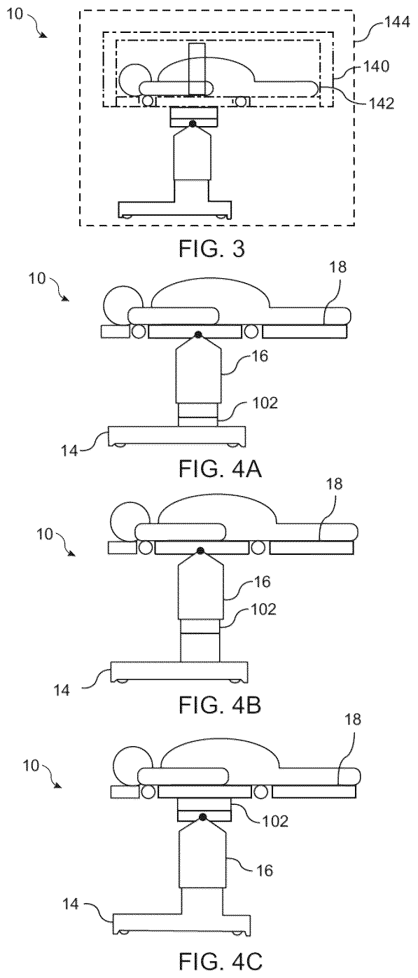

FIG. 3 schematically illustrates the different loads the load determination unit 104 can determine with the data delivered by the load sensor unit 102. In FIG. 3, the measuring load, the active load and the total load are characterised by reference numerals 140, 142 and 144. The load determination unit 104 can determine the position of the related load centre for each one of these loads.

The measuring load is the load which acts on the load sensor arrangement 102. The measuring load corresponds to the load which is created by all persons, objects and forces on the operating table 10 above the load sensors. The measuring load corresponds to the load value which is measured by the load sensor arrangement 102.

The active load corresponds to the load which is caused by components which are not assigned to the patient bearing device 18 or the operating table 10 and persons and external forces and acts on the operating table the patient bearing device 18. The active load does not take into account the influence of the components assigned to the patient bearing device 18 and of recognised accessory parts. Only the other components of the patient bearing device 18 contribute to the active load, i.e. the components which are not assigned to the patient bearing device 18. These can be accessory parts, for example, which are not recognised by the operating table 10. Furthermore, the patient located on the patient bearing device 18 contributes to the active load. Moreover, all forces acting externally on the patient bearing device 18, which are applied to the patient bearing device 18 by persons and/or objects outside the operating table 10 for example, contribute to the active load. Generally, the active load is the measuring load without the influence of the known objects such as table plate parts, recognised accessories etc.

The total load is the load which results from the measuring load and from a load caused by components which are assigned to the operating table 10 and are below the load sensor arrangement 102. Consequently, the total load considers loads from components which are located below the load sensor arrangement 102 and cannot be measured by the load sensor arrangement 102 and thus do not contribute to the measuring load. Consequently, the total load is the load which results from the complete operating table 10, the patient, the components assigned to the operating table 10, the components not assigned to the operating table 10 and other external forces.

FIGS. 4A to 4C schematically show the operating table 10 according to the disclosure in different embodiments.

In the operating table 10, the load sensor arrangement 102 with the several load sensors is arranged between at least two parts of the operating table 10. In particular, the at least two parts substantially cannot be movable to one another. In this design, the at least two parts substantially do not move to one another, i.e. they substantially remain in the same position to one another, if, during operation of the operating table 10, in particular the patient bearing device 18 is adjusted, e.g. when trending and/or tilting and/or longitudinally and/or laterally displacing the patient bearing device 18. This applies both to the distance of the at least two parts to one another and the one or more angles the at least two parts include(s) together.

The load sensor arrangement 102 is preferably integrated in the operating table 10 so that the full load above the load sensors flows through the load sensor arrangement 102 or is transmitted by it.

The load sensor arrangement 102 can be arranged at different positions in the operating table 10. In the embodiment represented in FIG. 4A, the load sensor arrangement 102 is arranged between the foot 14 and the operating table column 16, while the load sensor arrangement 102 in FIG. 4B is integrated in the operating table column 16. In FIG. 4C, the load sensor arrangement 102 is adjacent to the interface between the patient bearing device 18 and the operating table column 16.

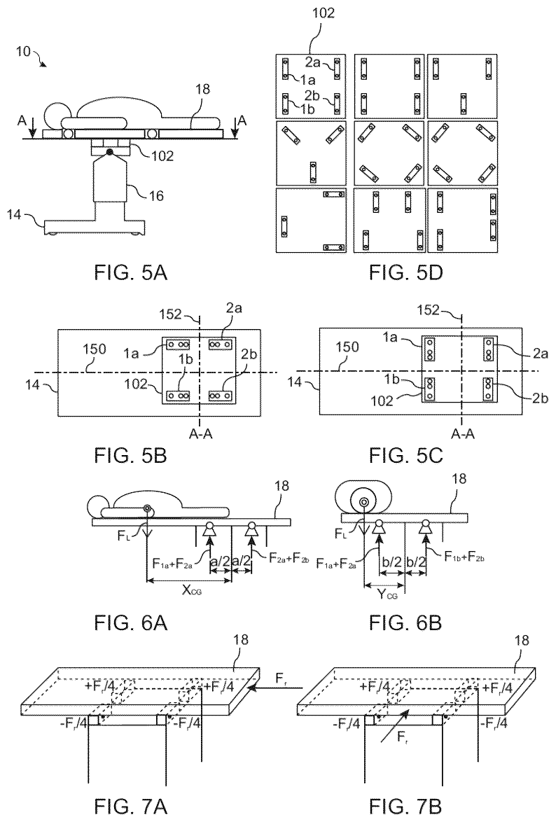

FIG. 5A shows the operating table 10 with a load sensor arrangement 102 arranged between the patient bearing device 18 and the operating table column 16. The load sensor arrangement 102 contains four structurally identical load sensors 1a, 1b, 2a and 2b which are arranged in parallel and mirror-inverted to one another. Two different variants for placing the force sensors 1a, 1b, 2a, 2b are illustrated in FIGS. 5B and 5C. FIGS. 5B and 5C each show a top view of the load sensor arrangement 102 along a line A-A which is drawn in FIG. 5A.

For alignment of the force sensors 1a, 1b, 2a, 2c, a first axis 150 and a second axis 152 are specified which are perpendicular to one another. The first axis 150 extends parallel to a main axis of the patient bearing device 18, while the second axis 152 runs perpendicular to this main axis, but parallel to the patient bearing device 18.

The force sensors 1a, 1b, 2a, 2c each have a main axis which is aligned parallel to the first axis 150 in FIG. 5B. In FIG. 5C, the main axes of the load sensors 1a, 1b, 2a, 2b are aligned parallel to the second axis 152. Further, the force sensors 1a, 1b, 2a, 2b are each arranged in pairs and mirror-symmetrically to the axes 150, 152. The pairs (1a, 1b), (1a, 2a), (1b, 2b) and (2a, 2b) each form a mirror-symmetrical force sensor pair. In some embodiments, the force sensors 1a, 1b, 2a, 2b are arranged in a 2×2 grid as represented. In some embodiments, the grid arrangement has at least two force sensors 1a, 1b, 2a, 2b on each side. In some embodiments, the force sensors 1a, 1b, 2a, 2b all lie in a single common plane in which both the first axis 150 and the second axis 152 are arranged.

The force sensors can also be arranged within the sensor arrangement 102 differently than in FIGS. 5B and 5C. Several example alternative arrangements of the force sensors in the sensor arrangement 102 are represented in FIG. 5D.

With the example of the sensor arrangement 102 represented in FIG. 5B or 5C, the measured load can be calculated by adding all of the forces measured by the sensors 1a, 1b, 2a, 2b. The corresponding centre can be calculated with the help of the torque compensation equation indicated below and the forces represented in FIGS. 6A and 6B. FIG. 6A shows a sectional representation along the x-axis and FIG. 6B shows a sectional representation along the y-axis. The torque compensation equation can be applied in both directions so that the x- and y-components of the centre can be determined:

$${F}_{L} = {F}_{1 a} + {F}_{2 a} + {F}_{1 b} + {F}_{2 b} \qquad ( 1 )$$

$${X}_{C G} = \frac{{F}_{1 a} + {F}_{1 b}}{{F}_{L}} a - \frac{a}{2} \qquad ( 2 )$$

$${Y}_{C G} = \frac{{F}_{1 a} + {F}_{2 a}}{{F}_{L}} b - \frac{b}{2} \qquad ( 3 )$$

In equations (1) to (3), FL is the weight force created by the patient. The forces F₁ₐ, F_{1b}, F₂ₐ and F_{2b} are the forces measured by the sensors 1a, 1b, 2a, 2b. The parameters a and b are the distances of the sensors in the x- and in the y-direction. X_{CG} and Y_{CG} are the x- and y-coordinates of the centre of the load caused by the patient.

The active load and the total load as well as their corresponding centre values can be calculated by adding or subtracting the corresponding components of the operating table 10 and their centre values which are stored in the data storage 110.

The arrangements of the sensors 1a, 1b, 2a, 2b proposed in FIGS. 5B and 5C makes the system robust against transverse forces Fr. Due to the symmetric arrangement, transverse forces Fr are cancelled, as shown in FIGS. 7A and 7B.

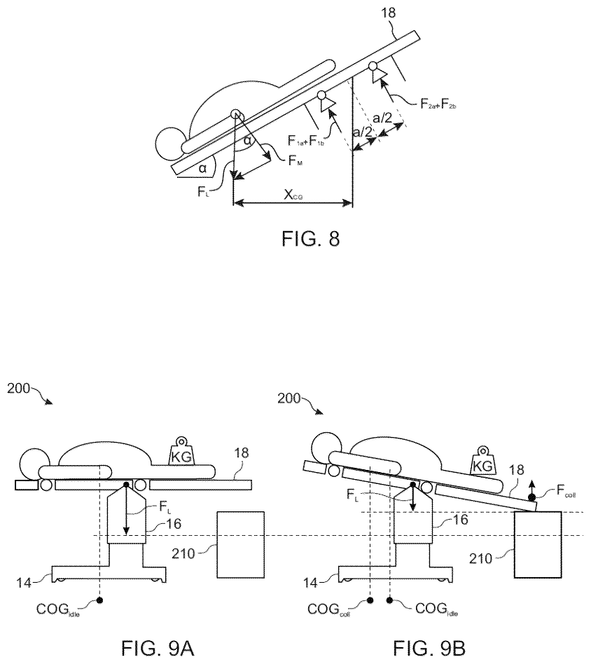

The cancellation of the transverse forces also enables the described system to reliably measure forces and centres if the patient bearing device 18 is in a trended position. FIG. 8 shows how the gravitation vector FL can be divided into two components. One component is laterally to the force sensors and is cancelled due to the effects explained above. The second component FM runs perpendicular to the force sensors or the main surface of the patient bearing device 18 and is measured reliably. When knowing the trend angle α of the patient bearing device 18, the actual force above the sensors and its centre can be calculated.

FIGS. 9A and 9B schematically show an operating table system 200 according to the disclosure which contains the elements of the operating table system 100 schematically represented in FIG. 2. The elements of the operating table system 100 are not represented in FIGS. 9A and 9B.

FIG. 9A shows the patient bearing device 18 in an unmoved condition, while in FIG. 9B, an anti-Trendelenburg-trend is embodied, wherein the foot section of the patient bearing device 18 is moved downwards. During the downwards movement, a collision of the patient bearing device 18 with an object 210 arranged below the patient bearing device 18 occurs.

The collision causes a decrease of the load F_{L} determined by the load determination unit 104. In FIGS. 9A and 9B, vectors for the load F_{L} are marked, the vector lengths of which indicate the size of the load F_{L} determined by the load determination unit 104. The collision transmits a part F_{coll} of the load to the collision site, whereby the load F_{L} determined by the load determination unit 104 decreases. Further, the collision leads to a jump of the load centre calculated by the load determination unit 104. In the resting condition, a load centre COG_{idle} is measured and after the collision, a displaced load centre COG_{coll} is measured.

The detection unit 113 is coupled to the load determination unit 104 and obtains the sizes determined by the load determination unit 104, in particular the measured load F_{L} and the load centre. The load F_{L} determined by the load determination unit 104 in the resting condition corresponds to the patient weight or the weight force caused by the patient. The detection unit 113 detects a possible collision of the patient bearing device 18 with an object, the ground on which the operating table 10 stands, or a part of the operating table 10 if the load F_{L} determined by the load determination unit 104 falls below a specified first threshold L_{coll} while the patient bearing device 18 or a segment of the patient bearing device 18 moves downwards. Consequently, a possible collision is detected if F_{L}<L_{coll} applies. If a possible collision is recognised, the movement of the patient bearing device 18 is stopped quickly in order to limit the force or the pressure on the collision point.

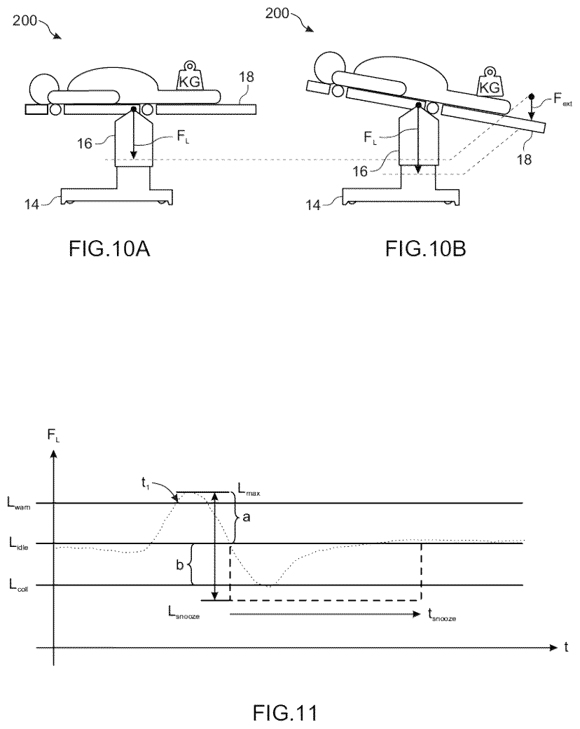

In FIGS. 10A and 10B, an external load Fₑₓₜ is applied to the patient bearing device 18 during a downwards movement. In FIG. 10A, the patient bearing device 18 is in a resting position and the load F_{L} is measured by the load determination unit 104. In FIG. 10B, the foot section of the patient bearing device 18 moves downwards and additionally, the external load Fₑₓₜ is applied to the patient bearing device 18, for example by a person supporting themselves on the patient bearing device 18. If the external load Fₑₓₜ is cancelled during the downwards movement, the resulting vibration of the load F_{L} determined by the load determination unit 104 can lead to a faulty collision warning as the load F_{L} can fall below the threshold L_{coll} due to the load vibrations although no collision has taken place.

FIG. 11 shows a load vibration which is caused by an external load, for example a push to the patient bearing device 18 from above. In the graph represented in FIG. 11, the load F_{L} determined by the load determination unit 104 is plotted against the time t. For example, the load F_{L} can be indicated as a weight in kilograms or as a weight force in Newton.

With the course of the load F_{L} represented as a dotted line it can be recognised that an external load is applied to the patient bearing device 18 during a downwards movement. The cancellation of the external load leads to load vibrations.

In the resting condition of the patient bearing device 18, i.e. before the beginning of the downwards movement, the load determination unit 104 determines a resting load whose level is used as a reference value. The load determined by the load determination unit 104 directly before the beginning of the downwards movement is referred to as L_{idle}.

The threshold L_{coll} is lower than the load L_{idle} determined directly before the beginning of the downwards movement and has a specified distance from the load L_{idle}. The distance of the threshold L_{coll} from the load L_{idle} corresponds to a collision threshold. If the load F_{L} falls below the threshold L_{coll}, i.e. if the load F_{L} decreases by at least the collision threshold starting from the load L_{idle}, the detection unit 113 detects a possible collision.

In order for a faulty collision detection due to a load vibration to be prevented, a second threshold L_{warn} is specified which is greater than the load L_{idle} and in FIG. 11 has the same amount of distance from the load L_{idle} as the threshold L_{coll}. The distance of the threshold L_{warn} from the load L_{idle} can also differ from the distance of the threshold L_{coll} from the load L_{idle}. The distance of the threshold L_{coll} from the load L_{idle} can be referred to as collision threshold and is marked as b in FIG. 11.

As soon as the load F_{L} determined by the load determination unit 104 exceeds the threshold L_{warn}, the detection unit 113 is deactivated for a specified time period. Within this time period, the detection unit 113 does not issue any collision warning in order to prevent a faulty collision detection. In the example shown in FIG. 11, the load F_{L} passes through the threshold L_{warn} at the time t₁.

Alternatively, it can be provided that the detection unit 113 detects a collision only under certain conditions after the load F_{L} has exceeded the threshold L_{warn}. For this, a third threshold L_{snooze} is specified which is smaller than the threshold L_{coll}. The condition for activating the threshold L_{snooze} is that the load F_{L} exceeds the threshold L_{warn}. During a following time t_{snooze}, a possible collision is only detected if the load F_{L} falls below the threshold L_{snooze}.

The time duration t_{snooze} has a specified length and can start, for example, as soon as the load F_{L} has exceeded the threshold L_{warn}, i.e. at the time t₁. Alternatively, the time duration t_{snooze} can start if the load F_{L} passes through the load value L_{idle} after the load F_{L} has exceeded the threshold L_{warn} before. This ensures that the time duration t_{snooze} is activated only if there is a load vibration. This case is represented in FIG. 11.

The threshold L_{snooze} can be determined with the help of a maximum load Lₘₐₓ which the load F_{L} reaches after exceeding the threshold L_{warn}. The distance of the threshold L_{snooze} from the maximum load Lₘₐₓ can be at least twice the distance of the maximum load Lₘₐₓ from the load value L_{idle}, for example. In FIG. 11, the distance of the maximum load Lₘₐₓ from the load value L_{idle} is marked with a. Consequently, the distance of the threshold L_{snooze} from the maximum load Lₘₐₓ can be at least 2a.

The reason for the distance 2a is that in case of a push to the patient bearing device 18 from above, the load F_{L} first increases by the value a, then the push bounces back like a wave and the measured load F_{L} falls below the original load value L_{idle}. Due to the damping, the “backlash” below the maximum load value Lₘₐₓ is smaller than 2a. The “backlash” should not be detected as a collision. However, if the “backlash” is greater than 2a (starting from the maximum load value Lₘₐₓ), then this can be detected as a possible collision.

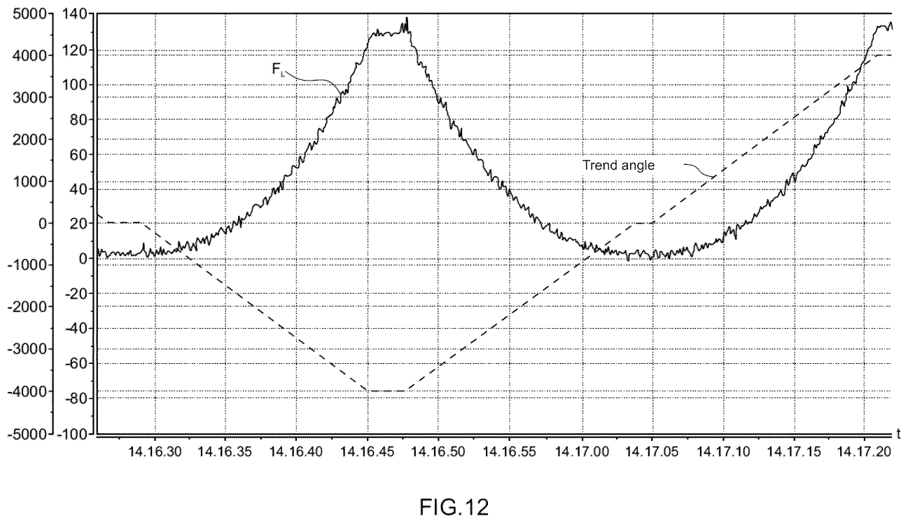

In FIG. 12, the trend angle of the patient bearing device 18 is plotted in degrees/100 and the load F_{L} determined by the load determination unit 104 is plotted in kilograms/10 against the time t. FIG. 12 shows that the measured force F_{L} changes with the trend angle, although the actual load on the patient bearing device 18 does not change. In order to avoid a faulty collision detection, the thresholds L_{coll} and L_{warn} can depend on the trend and/or tilt angles of the patient bearing device 18. Thus, the dependency of the measured load F_{L} on the trend and/or tilt angles can be at least partially compensated.

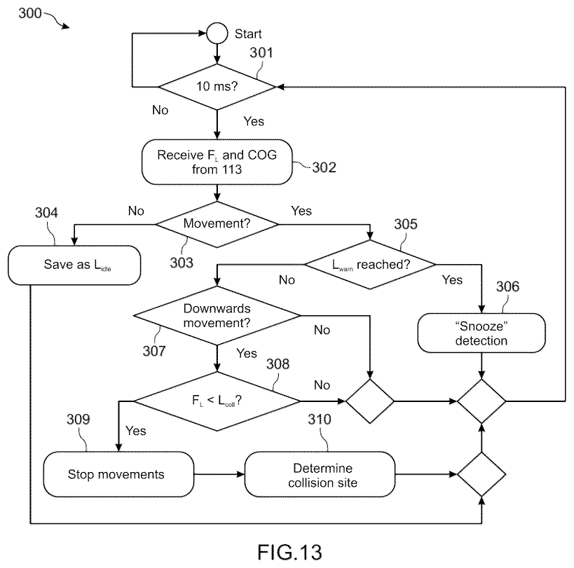

FIG. 13 shows a flow chart 300 which illustrates the course of a method for detecting a collision of the patient bearing device 18 with an object, a ground or a part of the operating table 10. The method is performed by the detection unit 113.

After the start, it is checked in decision step 301 whether 10 ms have passed. Consequently, the method starts from the beginning every 10 ms.

In step 302, the detection unit 113 obtains the measured load F_{L} and the load centre COG from the load determination unit 104.

In decision step 303, it is checked whether the patient bearing device 18 or at least one segment of the patient bearing device 18 moves in any way.

If the result of the decision step 303 is “no”, the current load value F_{L} is stored as load value L_{idle} in step 304 and the method returns to the decision step 301. If the result is “yes”, it is evaluated in decision step 305 whether the current load F_{L} has reached or exceeded the threshold L_{warn}.

If the current load F_{L} has reached or exceeded the threshold L_{warn}, a snooze time is activated for a specified duration in step 306. During this time, the detection unit 113 does not detect any possible collision. After the snooze time has expired, the method returns to the decision step 301.

If the current load F_{L} did not reach or exceed the threshold L_{warn}, it is checked in decision step 307 whether the patient bearing device 18 or at least one segment of the patient bearing device 18 moves downwards. If this is not the case, the method returns to the decision step 301.

If a downwards movement was determined, it is evaluated in decision step 308 whether the current load F_{L} fulfils the inequation F_{L}<L_{coll}, wherein in particular L_{coll}=L_{idle}-b applies. If this is the case, the movement of the patient bearing device 18 or of its segment is stopped in step 309 and the collision site is determined in step 310. Afterwards, the method returns to the decision step 301.

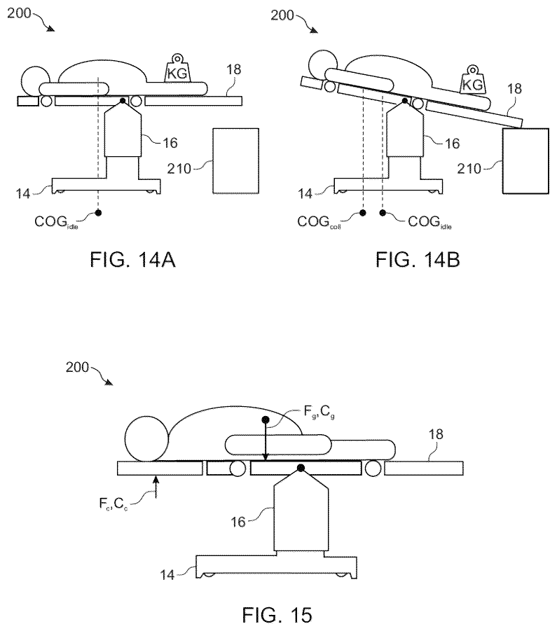

FIGS. 14A and 14B show, similar to FIGS. 9A and 9B, a jump of the load centre calculated by the load determination unit 104 which is caused by a collision of the patient bearing device 18 with the object 210 during a downwards movement. In the resting condition, a load centre COG_{idle} is measured and after the collision, a displaced load centre COG_{coll} is measured.

The detection unit 113 can determine as an additional condition for a possible collision whether the load centre determined by the load determination unit 104 changes abruptly during the downwards movement of the patient bearing device 18 or a segment of the patient bearing device 18.

FIG. 15 illustrates the determination of a collision force and a collision site. Before a collision, the load determination unit 104 measures the weight force F_{g} caused by the patient as a load F_{L},idle. The measured load centre COG_{idle} before the collision is equal to the load centre C_{g} of the patient:

$${F}_{L , idle} = {F}_{g} \qquad ( 4 )$$

$${COG}_{idle} = {C}_{g} \qquad ( 5 )$$

The collision causes a force F_{c} on the patient bearing device 18 on a site or centres C_{c}. During the collision, the load determination unit 104 measures the following load F_{L,coll} and the following load centre COG_{coll}:

$${F}_{L , coll} = {F}_{g} - {F}_{c} \qquad ( 6 )$$

$${COG}_{coll} = \frac{{C}_{g} * {F}_{g} + {C}_{c} * {F}_{c}}{{F}_{L , coll}} \qquad ( 7 )$$

Equations (6) and (7) can be rewritten as follows:

$${F}_{c} = {F}_{g} - {F}_{L , c o l l} \qquad ( 8 )$$

$${C}_{c} = \frac{C O {{G}_{coll}}^{} * {F}_{L , coll} - {C}_{g} * {F}_{g}}{{F}_{c}} \qquad ( 9 )$$

During the collision, the force F_{c} increases and the site C_{c} of the impact is nearly constant. In this case, a collision can be detected. If the collision site C_{c} is not constant, the increase of the collision force F_{c} can be due to a malfunction and not to a collision. If the force F_{c} decreases or remains constant, no collision can be present.

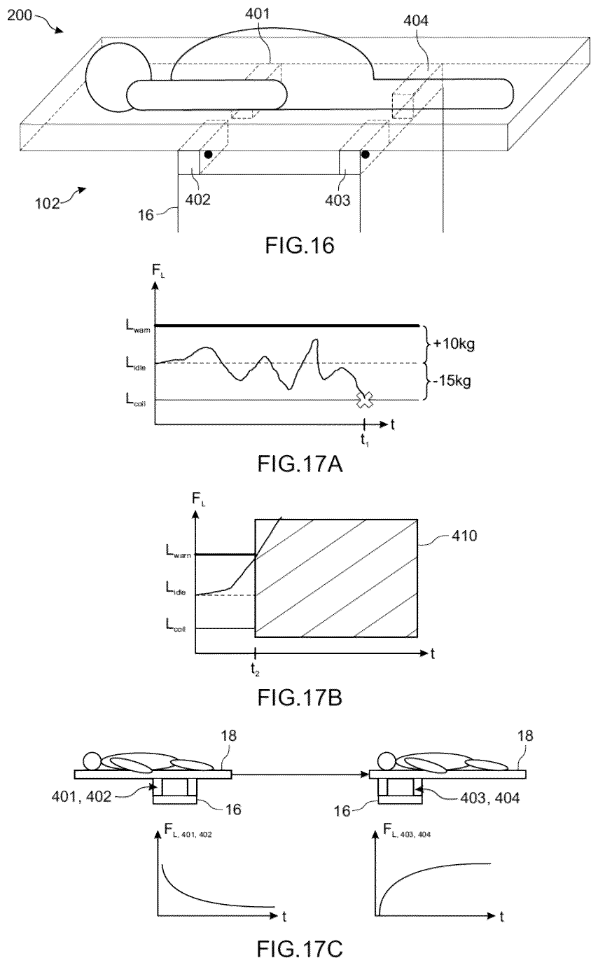

FIG. 16 shows a design of the load sensor arrangement 102 with four load sensors 401, 402, 403, 404. Each joint with which the patient bearing device 18 or a segment of the patient bearing device 18 can be moved, is assigned to one or more of the load sensors 401, 402, 403, 404. The assigned sensors are most affected during the respective movement. As an example, an assignment of joints which cause a movement of the patient bearing device 18 or of a segment thereof in a certain direction to certain sensors of the load sensors 401, 402, 403, 404 is represented in the following Table 1.

TABLE 1

| | | Assigned load |
|---|---|---|
| Joint | Direction | sensors |
| Rear right | Downwards | 402 |
| Rear left | Downwards | 401 |
| Leg right | Downwards | 403 |
| Leg left | Downwards | 404 |
| Tilting | Left | 401, 404 |
| Tilting | Right | 402, 403 |
| Trending | Normal | 403, 404 |
| Trending | Reversed | 401, 402 |
| Go up/down | Downwards | 401, 402, 403, 404 |

Depending on the type of movement, the detection unit 113 monitors those load sensors which are assigned to the joint which executes the movement. The detection unit 113 analyses the forces which act on the monitored load sensors.

If the analysed forces drop sharply, the detection unit 113 can conclude that there is a possible collision. But the sharp drop of the forces should not be caused by the movement of the patient bearing device 18.

Furthermore, the detection unit 113 can check whether a temporal derivation of the analysed forces falls below a specified fourth threshold during a possible collision. If the derivation of the analysed forces falls below the fourth threshold, the detection unit can determine that there is a possible collision.

FIGS. 17A to 17C show different application cases of the operating table system according to the disclosure.

In FIG. 17A, the load F_{L} determined by the load determination unit 104 is plotted against the time t. Before the beginning of a downwards movement, a load F_{L} of 90 kg was determined. The threshold values L_{coll} and L_{warn} were set so that L_{coll} is below L_{idle} (=90 kg) by 15 kg, i.e. the collision threshold b, and L_{warn} is above L_{idle} by 10 kg.

It can be taken from the temporal course of the load F_{L} that the detection unit 113 does not detect a collision if the load F_{L} increases or drops progressively or monotonously. Only when the load F_{L} falls below the threshold L_{coll} at the time t₁, a possible collision is detected.

In FIG. 17B, the load F_{L} at the time t₂ exceeds the threshold L_{warn}. Afterwards, the detection unit 113 ignores the course of the load F_{L} for a certain time period symbolised by an area 410. During this time period, the detection unit 113 does not determine any possible collision.

In FIG. 17C, the patient bearing device 18 is displaced in the longitudinal direction from left (see left representation in FIG. 17C) to right (see right representation in FIG. 17C) without the patient bearing device or an element thereof being moved downwards. The load sensor arrangement 102 has four load sensors 401, 402, 403, 404, wherein the load sensors 401, 402 are arranged on the left side and the load sensors 403, 404 are arranged on the right side of the operating table 10.

At the beginning of the displacement of the patient bearing device 18, the patient bearing device 18 is on the left side of the operating table column 16. In this case, there is a large force or load F_{L,401,402} on the load sensors 401, 402 arranged left and only a small force or load F_{L,403,404} on the load sensors 403, 404 arranged right, as can be taken from the graphs with the load courses shown in FIG. 17C. The further the patient bearing device 18 is displaced to the right, the smaller the load F_{L,401,402} and the greater the load F_{L,403,404}. However, the measured total load F_{L} remains stable and does not lead to a collision detection.

Example embodiments and variants corresponding to the present disclosure are described in the following list of clauses and options:
Clause 1: A system (100, 200) for detecting a collision of a patient bearing device (18) with an object, a ground or a part of an operating table (10), wherein the system (100, 200) comprises:
   i. a patient bearing device (18), in particular a surgical patient bearing device (18), which can be used as a part of an operating table (10);
   ii. a load sensor arrangement (102) with at least one load sensor (401, 402, 403, 404) which issues sensor values;
   iii. a load determination unit (104) which determines a load with the sensor values, wherein the load comprises a load acting on the load sensor arrangement (102) or a load acting on the patient bearing device (18); and
   iv. a detection unit (113) which detects a possible collision of the patient bearing device (18) with an object, a ground or a part of the operating table (10) if the load determined by the load determination unit (104) falls below a specified first threshold while the patient bearing device (18) or at least one segment of the patient bearing device (18) moves downwards.
Clause 2: The system (100, 200) according to clause 1, wherein the detection unit (113) temporarily does not indicate any possible collision after the load determined by the load determination unit (104) has exceeded a specified second threshold.
Clause 3: The system (100, 200) according to clause 1, wherein, after the load determined by the load determination unit (104) has exceeded a specified second threshold, the detection unit (113) temporarily detects a possible collision if the load determined by the load determination unit (104) falls below a specified third threshold which is smaller than the first threshold.
Clause 4: The system (100, 200) according to any one of the preceding clauses, wherein at least for a part of the axes about which the patient bearing device (18) or the at least one segment of the patient bearing device (18) can be trended or tilted during the downwards movement, and/or for a lowering of the patient bearing device (18) by means of a lifting column (16), the first threshold and/or the second threshold and/or the third threshold are each individually specified.
Clause 5: The system (100, 200) according to any one of the preceding clauses, wherein the first threshold and/or the second threshold and/or the third threshold are each variable and depend on a trend angle and/or tilt angle of the patient bearing device (18) or of the at least one segment of the patient bearing device (18).
Clause 6: The system (100, 200) according to any one of the preceding clauses, wherein an amount of a distance of the first threshold from a load determined by the load determination unit (104) before the beginning of the downwards movement is nearly as large as a distance of the second threshold from the load determined before the beginning of the downwards movement.
Clause 7: The system (100, 200) according to any one of the preceding clauses, wherein the detection unit (113) sets the first threshold and/or the second threshold so that a distance of the first threshold and/or a distance of the second threshold from the load are nearly constant during the downwards movement.
Clause 8: The system (100, 200) according to any one of the preceding clauses, wherein
   i. the load determination unit (104) additionally determines a centre of the load with the sensor values; and ii. the detection unit (113), as an additional condition for a possible collision of the patient bearing device (18) with an object, a ground or a part of the operating table (10), determines whether the load centre determined by the load determination unit (104) changes abruptly during the downwards movement of the patient bearing device (18) or of the at least one segment of the patient bearing device (18).
Clause 9: The system (100, 200) according to any one of the preceding clauses, wherein
   i. the detection unit (113) determines a force caused by a possible collision and acting on the patient bearing device (18) and/or a site where the patient bearing device (18) possibly collides with an object, a ground or a part of the operating table (10); and
   ii. the detection unit (113), as an additional condition for a possible collision of the patient bearing device (18) with an object, a ground or a part of the operating table (10), determines whether the force caused by the possible collision increases during the possible collision and/or the collision site is approximately constant.
Clause 10: The system (100, 200) according to clause 9, wherein the detection unit (113) determines the force caused by the possible collision and/or the collision site with a change, which occurred during the possible collision, of the load determined by the load determination unit (104) and/or of the load centre determined by the load determination unit (104) and/or of the sensor values issued by at least a part of the load sensors (401, 402, 403, 404).
Clause 11: The system (100, 200) according to any one of the preceding clauses, wherein
   i. the load sensor arrangement (102) has several load sensors (401, 402, 403, 404) which issue sensor values;
   ii. a respective selection of the load sensors (401, 402, 403, 404) is assigned to at least a part of the possible movements of the patient bearing device (18) or of the at least one segment of the patient bearing device (18) about different axes and/or by means of a lifting column (16); and
   iii. during a movement of the patient bearing device (18) or of the at least one segment of the patient bearing device (18), the detection unit (113) analyses the forces acting on the load sensors (401, 402, 403, 404) assigned to this movement.
Clause 12: The system (100, 200) according to clause 11, wherein, as an additional condition for a possible collision of the patient bearing device (18) with an object, a ground or a part of the operating table (10), the detection unit (113) determines whether the analysed forces fall below a specified force threshold during a possible collision.
Clause 13: The system (100, 200) according to clause 11 or 12, wherein, as an additional condition for a possible collision of the patient bearing device (18) with an object, a ground or a part of the operating table (10), the detection unit (113) determines whether a derivation of the analysed forces falls below a fourth threshold during a possible collision.
Clause 14. The system (100, 200) according to any one of the preceding clauses, wherein the load sensor arrangement (102) has several load sensors (401, 402, 403, 404) which issue sensor values, and the load sensors (401, 402, 403, 404) have at least one of the following features:
   i. the load sensors (401, 402, 403, 404) are arranged in a single common plane;
   ii. the load sensors (401, 402, 403, 404) are arranged in a grid;
   iii. the load sensors (401, 402, 403, 404) have a longitudinal shape;
   iv. the load sensors (401, 402, 403, 404) are aligned mirror-symmetrically with regard to a first axis and mirror-symmetrically with regard to a second axis which is aligned orthogonally to the first axis; and
   v. the load sensors (401, 402, 403, 404) are arranged between at least two parts of the operating table (10) which are substantially not movable to one another.
Clause 15: The system (100, 200) according to any one of the preceding clauses, wherein the detection unit (113), after the detection of a possible collision of the patient bearing device (18) with an object, a ground or a part of the operating table (10), creates a collision signal so that it indicates a safety-critical condition of the operating table (10), an acoustic and/or optical warning signal and/or a warning signal in text form is created and/or a movement of the patient bearing device (18) and/or of the operating table (10) is slowed down or stopped and/or at least one function of the patient bearing device (18) and/or of the operating table (10) is blocked.
Clause 16: The system (100, 200) according to any one of the preceding clauses, wherein the patient bearing device (18) is part of an operating table (10) and the operating table (10) further comprises a base (14) and a column (16) and wherein the load sensor arrangement (102) is arranged in the column (16).
Clause 17: The system (100, 200) according to any one of the preceding clauses, wherein the detection unit (113) detects a possible collision if the load determined by the load determination unit (104) decreases by at least one collision threshold during a downwards movement of the patient bearing device (18) or of the at least one segment of the patient bearing device (18).
Clause 18: The system (100, 200) according to any one of the preceding clauses, wherein the detection unit (113) detects a possible collision if the load determined by the load determination unit (104) decreases by at least one collision threshold during a downwards movement of the patient bearing device (18) or of the at least one segment of the patient bearing device (18), and
   i, wherein the system (100, 200) sets the collision threshold based on one or more of the following variables: a position of the patient bearing device (18), an angle of the patient bearing device (18), a joint angle of a joint within the patient bearing device (18), a displacement and/or trend and/or tilt position of the patient bearing device (18) and a current type of movement of the patient bearing device (18).
Clause 19: The system (100, 200) according to any one of the preceding clauses, wherein the system (100, 200), if the load determined by the load determination unit (104), in particular during a downwards movement of the patient bearing device (18) or of the at least one segment of the patient bearing device (18), increases by at least one false warning trigger amount, temporarily ignores all possible collisions due to decreases of the load determined by the load determination unit (104).
Clause 20: The system (100, 200) according to any one of the preceding clauses, wherein the detection unit (113) compares loads determined by the load determination unit (104) if the patient bearing device (18) stands still with loads determined by the load determination unit (104) if the patient bearing device (18) later moves downwards, wherein in particular a lower load if the patient bearing device (18) later moves downwards is an indication of a possible collision, wherein in particular a load which is lower by at least one collision threshold if the patient bearing device (18) moves downwards is an indication of a possible collision.
Clause 21: The system (100, 200) according to any one of the preceding clauses, wherein the detection unit (113) is only configured to detect collisions between the patient bearing device (18) and an object, a ground or a part of the operating table (10) below the patient bearing device (18) while the patient bearing device (18) or the at least one segment of the patient bearing device (18) moves downwards; and
   i, wherein the system (100, 200) in particular also comprises at least one other separate collision detection unit.
Clause 22: A method for detecting a collision of a patient bearing device (18) with an object, a ground or a part of an operating table (10), wherein:
   i. the patient bearing device (18) can be used as part of an operating table (10) and in particular is a surgical patient bearing device (18);
   ii. a load sensor arrangement (102) with at least one load sensor (401, 402, 403, 404) which issues sensor values is provided;
   iii. a load is determined with the sensor values, wherein the load comprises a load acting on the load sensor arrangement (102) or a load acting on the patient bearing device (18); and
   iv. a possible collision of the patient bearing device (18) with an object, a ground or a part of the operating table (10) is detected if the determined load falls below a specified first threshold while the patient bearing device (18) or at least one segment of the patient bearing device (18) moves downwards.

1.-22. (canceled)

23. A system for detecting a collision of a patient bearing device with an object, a ground or a part of an operating table, the system comprising:
the patient bearing device which is capable of use as a part of an operating table;
a load sensor arrangement having at least one load sensor configured to issue sensor values;
a load determination unit configured to determine a load with the sensor values, the load comprising a load acting on the load sensor arrangement or a load acting on the patient bearing device; and
a detection unit configured to detect a possible collision of the patient bearing device with said object, said ground or said part of the operating table when the load determined by the load determination unit falls below a specified first threshold while the patient bearing device or at least one segment of the patient bearing device moves downwards.

24. The system according to claim 23, wherein the detection unit is configured to, for a period of time of about 0.5 to about 10 seconds, not indicate any possible collision after the load determined by the load determination unit has exceeded a specified second threshold.

25. The system according to claim 23, wherein, after the load determined by the load determination unit has exceeded a specified second threshold, the detection unit is configured to, for a period of time of about 0.5 to about 10 seconds, detect a possible collision when the load determined by the load determination unit falls below a specified third threshold which is smaller than the first threshold.

26. The system according to claim 25, wherein at least for a part of the axes about which the patient bearing device or the at least one segment of the patient bearing device can be trended or tilted during the downwards movement, or for a lowering of the patient bearing device by a lifting column, the first threshold, the second threshold, and the third threshold are each individually specified.

27. The system according to claim 25, wherein the first threshold, the second threshold, and the third threshold are each variable and depend on a trend angle or a tilt angle of the patient bearing device or of the at least one segment of the patient bearing device.

28. The system according to claim 24, wherein an amount of a distance of the first threshold from a load determined by the load determination unit before the beginning of the downwards movement is nearly as large as a distance of the second threshold from the load determined before the beginning of the downwards movement.

29. The system according to claim 24, wherein the detection unit is configured to set the first threshold or the second threshold so that a distance of the first threshold or a distance of the second threshold from the load are nearly constant during the downwards movement.

30. The system according to claim 23, wherein:
the load determination unit is additionally configured to determine a centre of the load with the sensor values; and
the detection unit, as an additional condition for a possible collision of the patient bearing device with said object, said ground, or said part of the operating table, is configured to determine whether the load centre determined by the load determination unit changes abruptly during the downwards movement of the patient bearing device or of the at least one segment of the patient bearing device.

31. The system according to claim 23, wherein:
the detection unit is configured to determine a force caused by a possible collision and acting on the patient bearing device or a site where the patient bearing device possibly collides with said object, said ground, or said part of the operating table; and
the detection unit, as an additional condition for a possible collision of the patient bearing device with said object, said ground, or said part of the operating table, is configured to determine whether the force caused by the possible collision increases during the possible collision or the collision site is approximately constant.

32. The system according to claim 31, wherein the detection unit is configured to determine the force caused by the possible collision or the collision site with a change, which occurred during the possible collision, of the load determined by the load determination unit or of the load centre determined by the load determination unit or of the sensor values issued by at least a part of the load sensors.

33. The system according to claim 23, wherein
the load sensor arrangement has a plurality of load sensors configured to issue the sensor values;
a respective selection of the load sensors is assigned to at least a part of the possible movements of the patient bearing device or of the at least one segment of the patient bearing device about different axes or by a lifting column; and
during a movement of the patient bearing device or of the at least one segment of the patient bearing device, the detection unit is configured to analyse the forces acting on the load sensors assigned to said movement.

34. The system according to claim 33, wherein, as an additional condition for a possible collision of the patient bearing device with said object, said ground, or said part of the operating table, the detection unit is configured to determine whether the analysed forces fall below a specified force threshold during a possible collision.

35. The system according to claim 33, wherein, as an additional condition for a possible collision of the patient bearing device with said object, said ground, or said part of the operating table, the detection unit is configured to determine whether a derivation of the analysed forces falls below a fourth threshold during a possible collision.

36. The system according to claim 23, wherein the load sensor arrangement comprises a plurality of load sensors configured to issue the sensor values, and the load sensors have at least one of the following features:
the load sensors are arranged in a single common plane;
the load sensors are arranged in a grid;
the load sensors have a longitudinal shape;
the load sensors are aligned mirror-symmetrically with regard to a first axis and mirror-symmetrically with regard to a second axis which is aligned orthogonally to the first axis; and/or
the load sensors are arranged between at least two parts of the operating table which are substantially not movable relative to one another.

37. The system according to claim 23, wherein the detection unit, after the detection of a possible collision of the patient bearing device with said object, said ground, or said part of the operating table, is configured to create a collision signal so that it indicates a safety-critical condition of the operating table, an acoustic or optical warning signal or a warning signal in text form is created or a movement of the patient bearing device or of the operating table is slowed down or stopped or at least one function of the patient bearing device or of the operating table is blocked.

38. The system according to claim 23, wherein the patient bearing device is part of an operating table and the operating table further comprises a base and a column and wherein the load sensor arrangement is arranged in the column.

39. The system according to claim 23, wherein the detection unit is configured to detect a possible collision when the load determined by the load determination unit decreases by at least one collision threshold during a downwards movement of the patient bearing device or of the at least one segment of the patient bearing device.

40. The system according to claim 23, wherein the detection unit is configured to detect a possible collision when the load determined by the load determination unit decreases by at least one collision threshold during a downwards movement of the patient bearing device or of the at least one segment of the patient bearing device, and
wherein the system sets the collision threshold based on one or more of the following variables: a position of the patient bearing device, an angle of the patient bearing device, a joint angle of a joint within the patient bearing device, a displacement or trend or tilt position of the patient bearing device, and a current type of movement of the patient bearing device.

41. The system according to claim 23, wherein if the load determined by the load determination unit during a downwards movement of the patient bearing device or of the at least one segment of the patient bearing device, increases by at least one false warning trigger amount, the system is configured to temporarily ignore all possible collisions due to decreases of the load determined by the load determination unit.

42. The system according to claim 23, wherein the detection unit is configured to compare loads determined by the load determination unit if the patient bearing device stands still with loads determined by the load determination unit if the patient bearing device later moves downwards, wherein a lower load if the patient bearing device later moves downwards is an indication of a possible collision, and wherein a load which is lower by at least one collision threshold if the patient bearing device moves downwards is an indication of a possible collision.

43. The system according to claim 23, wherein the detection unit is only configured to detect collisions between the patient bearing device and said object, said ground, or said part of the operating table below the patient bearing device while the patient bearing device or the at least one segment of the patient bearing device moves downwards; and
wherein the system also comprises at least one other separate collision detection unit.

44. A method for detecting a collision of a patient bearing device with an object, a ground, or a part of an operating table, wherein the patient bearing device is capable of use as part of an operating table, the method comprising:
providing a load sensor arrangement comprising at least one load sensor configured to issue sensor values;
determining a load with the sensor values, wherein the load comprises a load acting on the load sensor arrangement or a load acting on the patient bearing device; and
detecting a possible collision of the patient bearing device with said object, said ground, or said part of the operating table when the determined load falls below a specified first threshold while the patient bearing device or at least one segment of the patient bearing device moves downwards.
